(19) United States
(12) Patent Application Publication
(10) Pub. No.: US 2005/0206954 A1
(43) Pub. Date: Sep. 22, 2005

(54) Method, printing appliance and computer program product for printing a file on a stack of sheets containing inserted index sheets

(76) Inventors: Hartwig Schwier, MUNCHEN (DE); Dieter Jorgens, Baldham (DE); Hubert Drexler, Taufkirchen (DE); Ulrich Baumler, Poing (DE)

Correspondence Address: SCHIFF HARDIN, LLP;PATENT DEPARTMENT, 6600 SEARS TOWER, CHICAGO, IL, 60606-6473, US

(21) Appl. No.: 10/509,805

(22) PCT Filed: May 7, 2003
(86) PCT No.: PCT/EP03/04789

§ 371 Date: May 4, 2005

(30) Foreign Application Priority Data
May 8, 2002 (EP) 10220645.7

(51) Int. Cl. G06K 15/00; G06F 15/00

(52) U.S. Cl. 358/1.16; 358/1.15

(57) ABSTRACT

In a method for printing a file on sheets with register pages inserted between them, the file containing register page file parameters describing the register pages, register page print parameters that describe a stack of register pages at an input. In the event that, upon printing of the file, it is established using the register page file parameters that a register page is to be processed, the register page file parameters describing the register page to be printed are compared with the register page print parameters in order to establish whether the next register page to be drawn from the input stack coincides with the register page to be processed. In the event that this is not the case, drawing at least one or more register pages from the input stack and supplying one or more of them to an output until a register page coinciding with the register page to be printed is drawn from the input stack, and then processing and supplying that register page to the output.

### BACKGROUND

The disclosure concerns a method to print a file on sheets with register pages inserted in between them, as well as a method for printing a file on a register page.

Methods for printing of files on register pages are known. Register pages are typically rectangular sheets made from a rigid paper or cardboard with a flag that protrudes one piece at a rectangular region. Method for printing of register pages are, for example, known from U.S. Pat. No. 5,337,161, U.S. Pat. No. 6,163,784. U.S. Pat. No. 5,519,501, U.S. Pat. No. 5,201,622, U.S. Pat. No. 5,946,461 and U.S. Pat. No. 4,539,653. The methods often concern the positioning of the print image on the flag or the selection of the corresponding data that are to be printed on the flags. There are also methods in which the print image to be printed on the flags can be monitored (U.S. Pat. No. 5,519,501).

The published patent application U.S. 2001/0043365 specifies a system for the professional printing and binding of documents. This business area is designated as “production printing”, where the difference relative to printing systems of private users is emphasized. With the system specified here, printing groups with register pages can be printed and bound. So that the flags of the register pages can be correctly printed, markers (flags) are incorporated into the print file that respectively describe one register page. These register pages are then automatically picked up by the printer and printed during the print event and inserted between the further sheets of the printing group.

Professional printing systems are often equipped with a function that allows the automatic printing of register pages.

If a print job is executed that also contains the printing of register pages and an error occurs, it is thus very involved to correct this in the known systems. On the one hand, register pages must be manually inserted into the corresponding input tray, such that only complete sets of register pages are present, or the uppermost set of register pages must be manually supplemented such that a suitable register page lies on top that is picked up as the next by the present (possibly interrupted) printing event, printed and sorted into the further sheets to be printed.

Additionally, the known methods are not very flexible since a corresponding stack of register pages must be inserted into the input tray and the control must be correspondingly changed given use of a set of register pages with a different total number of register pages.

Known methods are difficult to integrate into automatic production processes for printing of documents divided by means of register pages, since errors in the production process cannot be automatically remedied and they are additionally not very flexible.

From WO 01/67266 A1, a printing system and a method for printing a print job are known with which a print job can be printed. This print job can comprise register pages and further pages to be arranged between the register pages. The register pages as well as the further pages are automatically picked up from the respective output shafts, printed and output.

DE 691 08 500 T2 (=EP 0 478 354 B1) concerns an electronic reprography system that comprises a scanner and a printing system. The printing system comprises a paper feeder in which the paper to be printed is transported. This system is equipped with a device, in particular a video camera, for automatic detection of an error. If an error is detected, the page in which the error has been established and all subsequent pages located in the paper feeder are separated out to a defined separation location. Additionally, up to three pages before the page in which the error has been determined can also be separated out. With this system, the pages located in the paper feeder are removed upon occurrence of an error. An automatic error remedy method is subsequently executed and the copy or print event is continued at a suitable point.

### SUMMARY

It is an object to achieve a method for printing a file on sheets with register pages inserted between them that enables both a simple error elimination and a larger flexibility in the printing of the register pages.

In a method for printing a file on sheets with register pages inserted between them, the file containing register page file parameters describing the register pages, register page print parameters that describe a stack of register pages at an input. In the event that, upon printing of the file, it is established using the register page file parameters that a register page is to be processed, the register page file parameters describing the register page to be printed are compared with the register page print parameters in order to establish whether the next register page to be drawn from the input stack coincides with the register page to be processed. In the event that this is not the case, drawing at least one or more register pages from the input stack and supplying one or more of them to an output until a register page coinciding with the register page to be printed is drawn from the input stack, and then processing and supplying that register page to the output.

### BRIEF DESCRIPTION OF THE DRAWINGS

FIG. 1 is a set of register pages with individual flags in plan view

FIG. 2 is a set of register pages with flags according to the waterfall principle;

FIG. 3 illustrates schematically in a block diagram, a system to execute the method that comprises a correspondingly designed printer;

FIG. 4 shows the method in a flow diagram; and

FIG. 5 illustrates a register page with two logical sides.

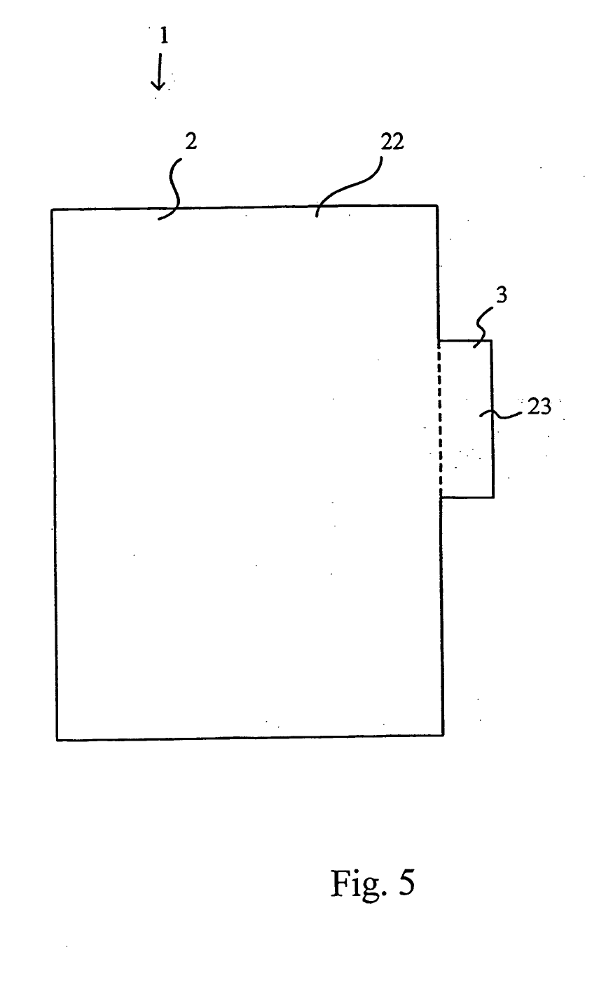

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

With the method of the preferred embodiment, a file is printed on sheets with register pages inserted in between them, whereby the file contains register page file parameters that specify the structuring processes. In a print control device, register page print parameters are stored that describe a stack of register pages present in an input shaft.

In the event that, upon printing the file, using the register page file parameters it is determined that a register page is to be printed, the register page file parameters specifying the register page to be printed are compared with the register page print parameters in order to establish whether the next register page to be drawn from the input chute coincides with the register page to be processed. In the event that this is not the case, so many register pages are drawn from the input chute and supplied to an output chute until a register page coinciding with the register page to be printed is drawn from the input chute and this is, if applicable, processed and supplied to an output chute accommodating the sheets. The register page is hereby inserted between the printed sheets and sheets stacked in the output chute.

The term “processing of register pages” means that a register page is either printed with a key, for example in the region of the flag, and/or is sorted into a stack of sheets in order to separate individual sections in the stack. To fulfill this separation function, it is not always necessary that the register pages be printed, in particular when register pages used are innately printed with a key.

The disclosed method uses the fact that a set of register pages typically comprises only five to twenty (possibly thirty) register pages and a plurality of stacks or sets of identical register pages are stored in an input tray. It is therefore possible, in the event that the association between the register page file parameters and the register page print parameters should be incorrect, that some register pages are drawn from the input tray until the association is established again. In other words, this means that, given a discrepancy between the register page file parameters and the register page print parameters, this is remedied via adaptation of the register page print parameters to the register page file parameters.

In the worst case, the total number of the register pages of a set minus one register page must be drawn from the input tray.

The preferred embodiment method can be very simply implemented in existing printing systems and completely automatically executed. The correct association of the register page print parameters with the register page file parameters can be established again at any time, for example after a paper jam or another interruption of the print event. No manual intervention whatsoever is necessary for this. This leads to a significant cost reduction given the use of register pages in a printing process. Since errors in the use of register pages are minimized or automatically remedied via the method, the quality of the printing process is significantly increased.

With the preferred embodiment method, register pages of a stack of register pages that have not been used in a preceding print job are also automatically removed from the input shaft in the event that a first register page of a stack of register pages is requested again. Also, in the method it is possible with the register page file parameters of a file to be printed to initiate only every x-th register page of a stack of register pages, whereby every i-th register page with i unequal to x is automatically removed from the input shaft. If, for example, fewer register pages are necessary than are contained in the stack, it can be advisable, for example, to pull in, to process and to insert between the printed sheets only every second or third register page of a stack. In the method, this can only be executed via determination of the register page file parameters defining the print job.

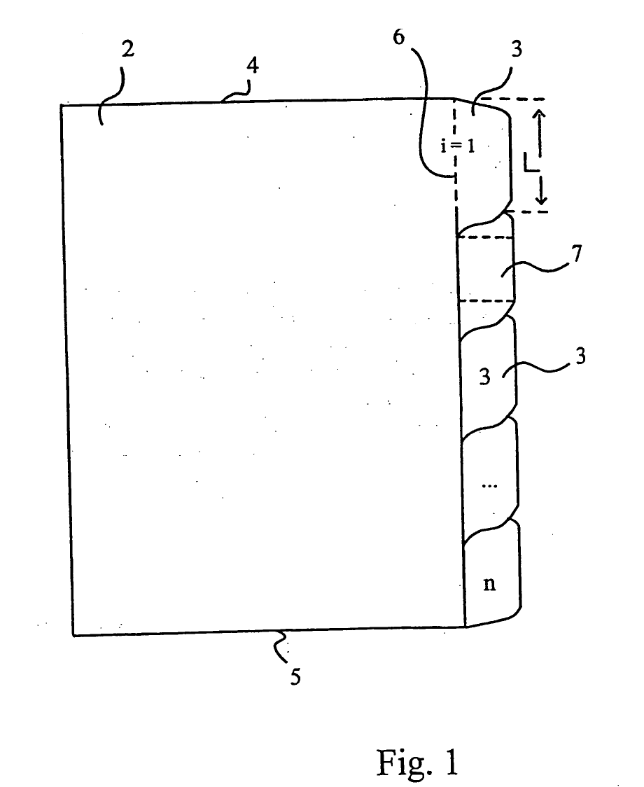

Register pages 1 (FIG. 1, 2) exhibit a rectangular area 2 with a strut-shaped section that extends somewhat over the edge of the area 2 and is designated as a flag 3.

In FIG. 1, a set of register pages is shown that are designed with single flags 3. The single flags are arranged on the right edge of the area 2 in the plan view. The flags 3 exhibit a length L. The register pages of a set are designed and sorted such that the flags 3 of two register pages adjacent in the set are respectively displaced relative to one another by the length L. In the set of register pages shown in FIG. 1, the flag 3 of the uppermost register page is designed terminating flush with the upper edge of the register page, and the flags of the register pages lying underneath are respectively displaced by the length L in the direction towards the lower edge of the register pages, such that all flags 3 are completely visible in the plan view of the complete set of register pages. The register pages in FIG. 1 are sorted from 1-n. There are also sets of register pages that are sorted in reverse (n-1).

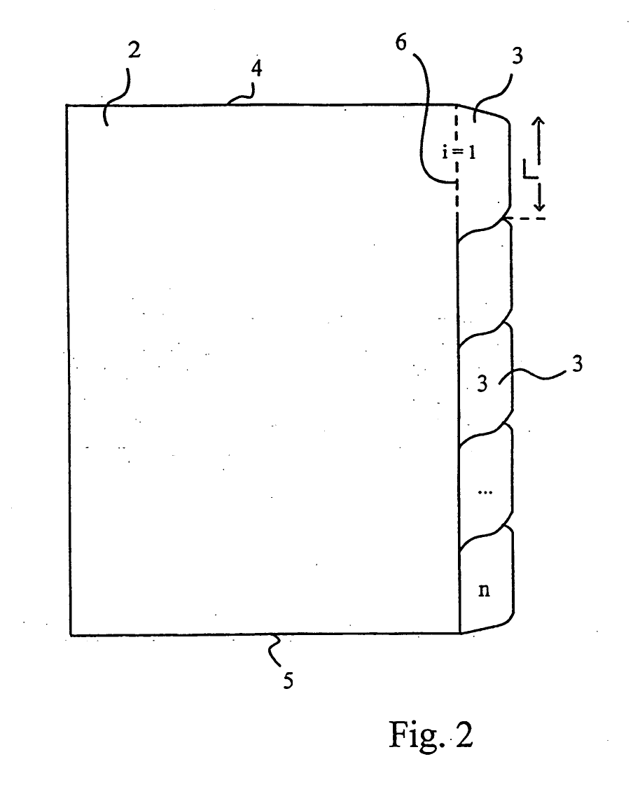

FIG. 2 shows a set of register pages with flags 3 according to the waterfall principle. The flags are again designed at the right edge 6 of an area 2 in the plan view. The flags 3 respectively extend from the upper edge 4 along the right edge 6 in the direction towards the lower edge 5. The flag 2 of the uppermost register page (i=1) extends over a length L from the upper edge 4 in the direction towards the lower edge 5. The flag 3 of the second register page (i=2) extends over a length of 2 L from the upper edge 4 in the direction towards the lower edge 5, and the i-th register page extends from the upper edge 4 over a region of i×L in the direction towards the lower edge 5. In these register pages with the flags according to the waterfall principal, respectively one region of the length L is visible from each flag 3 in a stack of the register pages. In this visible region, the flags 3 can be printed with an ordering specification. A printable region 7 is thus arranged in this visible flag region.

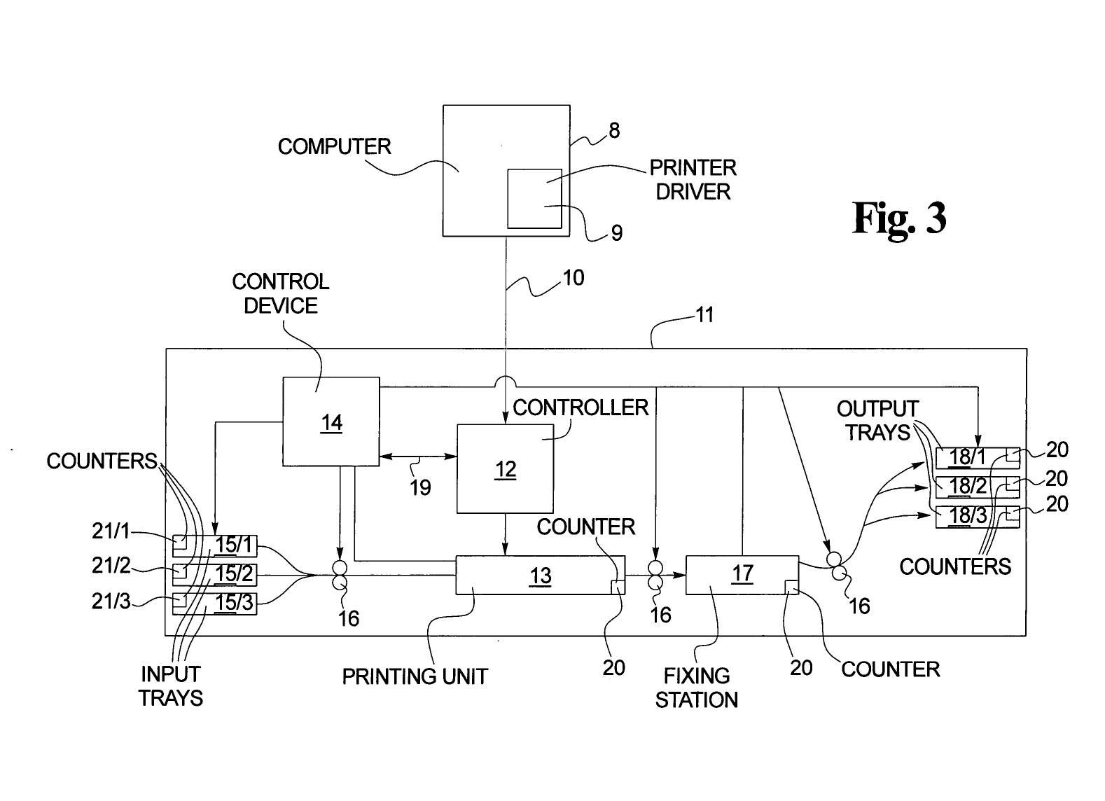

FIG. 3 schematically shows a system to execute the method of the preferred embodiment. This system comprises a computer 8 on which an application program to create a file to be printed (such as, for example, a text processing program, a character program or the like) is stored and can be executed. The computer 8 comprises an operating system that is provided with a printer driver 9 in which the file to be printed is prepared for a specific printer type or according to a specific print format (Postscript, PCL, PPML, AFPDS, PDF, IPDS, etc.) before it is sent to a printer 11 via a data line 10. The printer 11 comprises a controller 12 in which the files to be printed are converted into a control signal to control a printing unit 13. The printer is also provided with a control device 14 that is a processor unit and controls the activity of all individual elements, such as, for example, input trays 15, powered paper transport rollers 16, the printing unit 13, a fixing station 17 and output trays 18.

The control device 14 is connected with the control 12 via a data line 19 via which are transmitted either a complete copy of the incoming file to be printed or at least all of the data of the file to be printed necessary for control of the print 11, such as, for example, the number of the sheets to be printed and their formats as well as the communication that the control signals for specific pages are prepared by the controller 12 and are ready for printing. Using these signals, the control device 14 controls the input trays 15 such that a predetermined sheet to be printed (such as, for example, a white page of paper of a register page) is drawn from a specific input tray 15/1, 15/2, 15/3, is supplied to the printing unit 13, is printed there if applicable, is further transported from the printing unit 13 to the fixing station 17, and there is fixed and then deposited in a predetermined output tray 18/1, 18/2, 18/3.

In the printer 11, register page print parameters that exactly describe the sets of register pages stored in an input tray (for example the tray 15/1) are stored in the control device 14. The register page print parameters thus contain ordering criteria according to which the register pages stored in the input tray 15/1 are sorted. The register page print parameters can, for example, be comprised only of a type designation of the register pages and the number of the register pages stored in the tray 15/1. A further suitable distribution of the register page print parameters is stated in the following table:

| | | | | | | | | | | |
|---|---|---|---|---|---|---|---|---|---|---|
| | | | | | | | Flag | Flag | Edge | |
| | | | | Sorting | | Waterfall | width | height | cut | |
| | Tab | Basic | | inverse/ | | single | in | in mm | in | Edge |
| Index | ID | format | Manufacturer | successive | Sorting n | flag | mm | inner/edge | mm | steepness |

wherein:

Index: the number of the register page sets present in the input tray,
Tab ID: the number of the uppermost register page in a complete set of register pages,
Basic format: a standardized base format,
Manufacturer: a designation of the manufacturer of the register pages,
Sorting: whether the register pages are sorted from 1-n or n-1,
Distribution: the number of register pages in a complete set of register pages,
Waterfall individual flags: whether the register pages are designed with individual flags or according to the waterfall principle,
Flag width: in mm, for example a flag width of 13 mm,
The flag height: in mm, a flag height of, for example, 48 mm,
Edge cut: in mm, an edge cut of, for example, 7 mm, and
Edge steepness: a specific standardized edge steepness.

The register page print parameter can be adjusted via a user interface on the printer or be read out from a setup file or be loaded via a loadable file.

The file to be printed contains register page file parameters that are created in the application software on the computer 8 and describe the register pages in a corresponding manner. The format of the register page file parameters can be identical to the format of the register page print parameters. This format must at least be designed such that the parameters contained therein can be converted by the controller 12 or the control device 14 such that they can be related to the register page print parameters stored in the control device 4.

Using the register page print parameters, not only is the pick-up of a register page from the input tray 15/1 controlled by the control device 14, but rather the printing in the printing unit 13 is as well. This is elaborated on below.

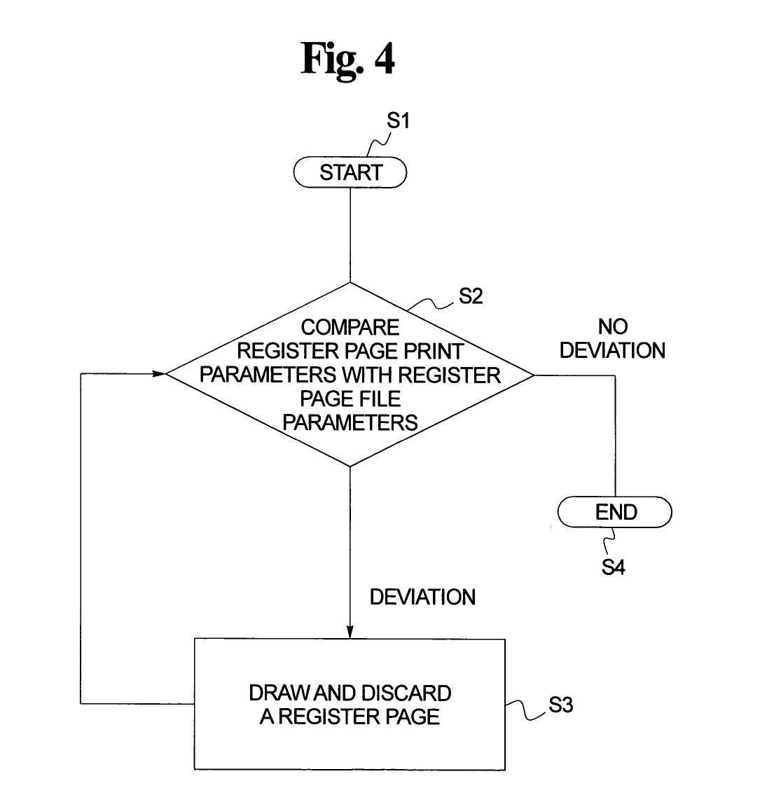

The method of the preferred embodiment for correction of errors in the control of register pages is subsequently explained using the flow diagram shown in FIG. 4. This method begins with the step S1. Given pick-up of a register page from the input shaft 15/1, it is checked by the control device whether a suitable register page already lies in the input tray 15/1, i.e. that the register page to be drawn next, which is normally the uppermost register page in the tray 15/1, exhibits the format that is required by the file to be printed, i.e. is a register page with a specific flag. This check occurs via a comparison of the register page print parameters with the register page file parameters (S2). When the format of the register page file parameters is identical to that of the register page print parameters, the comparison is a comparison in the strictly mathematical sense, whereby the identity of both parameter sets is checked. If the format of the register page file parameters differs from that of the register page print parameters, the comparison corresponds to a mapping (injective, surjective or bijective) of the register page file parameters to the register page print parameters according to a predetermined mapping instruction and the comparison of the mapped parameters.

If no suitable register page lies ready for pick up in the input tray 15/1, a register page is drawn (S3) from the input tray 15/1 and supplied to one of the output trays 18. It is subsequently checked again whether register page print parameters coincide with the register page file parameters (S2). When this is the case, this means that as many register pages have been drawn from the input tray until a suitable register page already lies in the input shaft 15/1. The method for compensating the register page print parameters with the register page file parameters is therewith ended (S4).

This method is stored as a software module in the control device 14.

The register pages drawn up to the presence of a suitable register page are subsequently designated as discarded register pages. The suitable register page can now be picked up, supplied to the printing unit 13, if applicable printed and be supplied to one of the output trays 18. Since a complete set of register pages ultimately comprises a small number of pages, for example 5 to 30 pages, in the worst case the number of register pages to be discarded is the total number of the register pages of a set minus one.

The discarded register pages can be deposited in one of the output trays 18/3 separate from the other register pages and the printed sheets that are, for example, deposited in the tray 18/1. The discarded register pages are hereby automatically separated from the generated stream of printed sheets and register pages. However, if the printer comprises only a single output tray, it is in principle also possible that the discarded register pages are printed with a corresponding error marking, for example in the print region of the flag. An operator of the printer must then remove the register pages provided with the error marking from the stack of register pages and printed sheets.

The method specified above to pick up and discard unsuitable register pages can be executed fully automatically. With this very simple method, different problems are solved in the area of the printing of register pages. If, for example, a paper jam exists in the printer, typically the jammed and incorrectly printed or not yet fixed sheets and register pages are removed from the printer. It can thus be that the register page file parameters of the file to be printed are reset by the number of the sheets and register pages removed in the paper jam. The register page file parameters that, for example, control the first register page of a set thus deviate from the register page print parameters describing the stack of register pages in the input tray 15/1, said register page print parameters describing, for example, the i-th register page. This difference is, as explained above, remedied via pick-up of register pages from the input tray and discarding of the same until the register page file parameters coincide with the register page print parameters.

The resetting of the register page file parameters in the file to be printed occurs, for example, by means of a counter 20 arranged in the printing unit 13 and/or a counter 20 arranged in the fixing station 17 and/or one or more counters 20 arranged at the output trays 18 that respectively count the number of the sheets or register pages passing through the printing unit 13 or the fixing station 17 or count the number the of the sheets or register pages deposited in the output trays 18. The use of such counters to determine the sheets and register pages incorrectly printed due to a paper jam and for corresponding resetting of the page count of the file to be printed is known.

Fill state counters 21 (21/1, 21/2, 21/3) are preferably arranged at the input trays 15 that determine the fill state of the individual input trays 15 and using which the control device 14 can correspondingly update the register page print parameters. However, if the conveyer is so reliable that no errors should occur in the region of the input trays upon pick-up of register pages or sheets, such counters are not necessary since the control device 14 can track the inventory of register pages solely via the controlled pick-up of the sheets and register pages.

In the region between the printing unit 13 and the output trays 18, the most different combinations of the arrangement of counters 20 in order to monitor the flow of printed material are also known. For the preferred embodiment, it is significant that it can occur given a paper jam that a register page already lies in the input tray 15/1 as a next register page to be drawn that is unsuitable for the further printing process, and this problem is remedied by compensation of the register page file parameters with the register page print parameters.

A further problem in conventional methods is when the number of necessary register pages in a print task or print job is less than the number of an available stack of register pages. In conventional methods, the existing set of register pages in the input tray would have to be exchanged with another set of register pages with a correspondingly adapted number of register pages. This problem is remedied with the preferred embodiment in that when, for example, only m register pages of a set with n register pages have been used in a print job, the remaining n-m register pages are automatically picked up before the next print job and discarded, such that a complete stack of register pages is again present in the input tray.

If register page stacks designed according to the waterfall principle are used, in the event that only a few register pages of a stack are necessary to divide a print job, for example every i-th, for example every second or every third register page of the stack can thus be used. With the method, only the register page file parameters of the print file are selected for this, such that only every i-th register page is activated. Should, for example, only every second register page be activated, only the first, third, fifth, etc. register page of a stack will be picked up and used to separate individual sections of a print job. However, if the second, fourth, sixth, etc. register page are present in the input tray, a deviation results between the register page file parameters and the register page print parameters that is automatically remedied with the method without further control instruction via pickup and deposition of the unnecessary register pages.

With the method, different problems that, for example, occur given the occurrence of a paper jam or given use of only a partial quantity of the register pages of a complete set of register pages are thus solved in a very simple manner. The method can be simply and retroactively integrated into existing printing systems. It is in particular suitable for high-capacity printing systems on which complex print jobs are executed fully automatically.

The printer of the preferred embodiment can optionally be provided with a sensor (for example a light barrier) to monitor the edges of the register pages. Sorting errors within a set of register pages can thus be detected. This allows the automatic correction of erroneously sorted sets of register pages.

It is often desired that the register pages are printed, in particular in the region of their flags. For this, a side format or a logical side can be set up that surround the area 2 and each flag 3 of a set of register pages. Within this logical side, any arbitrary point (and therewith also the region of the flags) can be accessed for printing. However, this method possesses the disadvantage that in principle regions that laterally terminate at the flags and are not present in the register page can also be printed.

In a preferred method to control the printing event, a logical side 22 that provides the region of the area 2 of a register page and a further logical side 23 that defines the printable region of the print flag are therefore provided for each register page. Using the register page print parameters, the positions of the logical sides 22, 23 for each individual register page are determined such that the register pages can be completely printed, however via the provision of the logical sides no region can be printed in which the register page should not be developed. This method can be integrated simply into a known AFPDS/IPDS print data stream, whereby here the N-up functionality is used in which a plurality of logical sides can be defined for a sheet to be printed. This method to control the printing event can also be used independent of the method specified above, in which unnecessary register pages are drawn from the input tray and not further processed, and thus represents an independent idea.

If register page print parameters are used that completely describe the shape of the register pages, such as, for example, the parameters stated above in the table, these register page print parameters can be used for definition of the printable region of the register page. A single printable region is hereby defined that exactly establishes the entire printable region of a register page, such that no region can be accessed in which the register page is not designed. Since the register page print parameters and the register page file parameters are designed corresponding to one another, the regions of the register pages to be printed can be defined in the same manner by means of the register page file parameters in the application software and corresponding commands can be made upon creation of a file to be printed. The use of the register page print parameters for definition of the region of a register page to be printed can be used independent of the method explained above for pick-up of unnecessary register pages.

The system and method is described above using an exemplary embodiment in which the register page print parameters are inserted into the file to be printed upon the creation of the file to be printed. In the framework of the preferred embodiment, it is also possible that the register page file parameters are incorporated into an additional file and this is coupled with the file to be printed. Such an additional file is, for example, the job ticket for print jobs, which can contain the register page file parameters. In the framework of the invention, the expression “printing of a file” is to be understood to the effect that the file can comprise a group of files in which the data to be printed is distributed. This allows, for example, the creation of register page file parameters independent of the file that contains the text to be printed and corresponds to a subsequently sorting of register pages.

In the exemplary embodiment specified above, the register pages are deposited in a single input tray. In the framework of the preferred embodiment, it is naturally also possible to distribute register pages in a plurality of input trays. For example, it can thus be appropriate to deposit each type of register page with a specific flag in a separate input tray. It is equally possible to respectively provide one input tray for different sets of register pages.

With the disclosed preferred embodiment, unsuitable sheets are automatically pulled from the input shaft and deposited in an output shaft. Problems that occur given a paper jam or in the use of only a part of a set of register pages are automatically remedied. The method is simple and can be retrofitted in existing printing systems.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

1-10. (canceled)

11. A method for printing a file on sheets with register pages inserted between them, the file containing register page file parameters describing the register pages, comprising the steps of:
storing register page print parameters that describe a stack of register pages existing in an input tray in a control device of a printer;
in the event that, upon printing of the file, it is established using the register page file parameters that a register page is to be processed, comparing the register page file parameters describing the register page to be printed with the register page print parameters in order to establish whether the next register page to be drawn from the input tray coincides with the register page to be processed; and
in the event that this is not the case, drawing register pages from the input tray and supplying them to an output tray until a register page coinciding with the register page to be printed is drawn from the input tray and then processing and supplying that register page to the output tray.

12. A method according to claim 11 wherein register pages not to be processed are supplied to a separate output tray not provided for the register pages to be processed.

13. A method according to claim 11 wherein register pages not to be processed are printed with an error marking.

14. A method according to claim 11 wherein the register pages drawn from the input tray are counted by a counting device and the register page print parameters are corrected using a determined counting value.

15. A method according to claim 11 wherein sheets printed in a printing unit of the printer are counted by a counting device and the register page file parameters are adjusted using the determined counting value.

16. A method according to claim 11 wherein the file to be printed exists in at least one of the print formats Postscript, PCL, PPML, AFPDS, IPDS and PDF.

17. A method according to claim 11 wherein the file is printed to the file comprising at least two logical sides, one of the two sides being associated with the flag of a register page and the other logical side being associated with a remaining region of the same register page.

18. A method according to claim 11 wherein the file is printed on a register page, the file comprising register page file parameters that define a shape of the register page to be printed and thus establish the region to be printed.

19. A printing device for printing a file on sheets with registered pages inserted between them, the file containing register page file parameters describing the register pages, comprising:
a controller in which the file to be printed is converted into a control signal to control a printing unit;
a control device, an input tray, a paper transport device, a printing unit, an output tray, and a software module stored in the control device;
the control device having stored therein register page print parameters that describe a stack of register pages existing in the input tray; and
the software module, in the event that upon printing of the file it is established using the register page file parameters that a register page is to be processed, the register page file parameters describing the register page to be printed are compared with the register print parameters in order to establish whether the next register page to be drawn from the input tray coincides with the register page to be processed, and in the event that this is not the case, drawing register pages from the input tray and supplying them to the output tray until a register page coinciding with the register page to be printed is drawn from the input tray, and then processing and supplying that register page to the output tray.

20. A computer program for operation on a control device of a printer for controlling a printing of a file on sheets with register pages inserted between them, the file containing register page file parameters describing the register pages, said program storing register page print parameters that describe a stack of register pages existing in an input tray, and in the event that upon printing of the file, it is established using the register page file parameters that a register page is to be processed, the register page file parameters describing the registered page to be printed are compared with the register page print parameters in order to establish whether the next register page to be drawn from the input tray coincides with the register page to be processed, and in the event that this is not the case, drawing register pages from the input tray and supplying them to an output tray until a register page coinciding with the register page to be printed is drawn from the input tray, and then processing and supplying that register page to the output tray.

21. A method for printing a file on sheets with register pages inserted between them, the file containing register page file parameters describing the register pages, comprising the steps of:
storing register page print parameters that describe a stack of register pages at an input;
in the event that, upon printing of the file, it is established using the register page file parameters that a register page is to be processed, comparing the register page file parameters describing the register page to be printed with the register page print parameters in order to establish whether the next register page to be drawn from the input stack coincides with the register page to be processed; and
in the event that this is not the case, drawing one or more register pages from the input tray and supplying one or more of them to an output stack until a register page coinciding with the register page to be printed is drawn from the input stack and then processing and supplying that register page to the output.
